(19) United States
(12) Patent Application Publication
(10) Pub. No.: US 2006/0291408 A1
(43) Pub. Date: Dec. 28, 2006

(54) Low power operation for network nodes

(76) Inventors: Jonathan Huang, Sunnyvale, CA (US); Lama Nachman, Santa Clara, CA (US); Vincent Hummel, Austin, TX (US); Ralph Kling, Sunnyvale, CA (US); Robert Adler, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/167,966

(22) Filed: Jun. 27, 2005

(51) Int. Cl. G08C 17/00

(52) U.S. Cl. 370/311

(57) ABSTRACT

In a wireless multi-hop network, in which data may pass from node to node through the network, a sleep/wake protocol may be used to reduce power consumption by placing various nodes into coordinated low power modes, and having the nodes wake up to maintain network connections and/or to pass data.

### BACKGROUND

In a multi-hop network, a particular message may be passed through multiple nodes until it reaches its destination, rather than being transmitted directly from the source node to the destination node without any intermediate hops. Multi-hop networks may frequently use battery-powered nodes. One example is a sensor network in which small battery-powered sensor devices (e.g., sensor devices sometimes called ‘motes’) may establish a wireless network to report their sensor data through each other until the data eventually reaches a device that can communicate with devices outside the network. Such sensor devices may have a very low duty cycle for data gathering, which can save on battery usage by powering up only infrequently to sense the environment. But these nodes may have to maintain radio contact with neighboring nodes so that any sensor's data may be relayed through the network. Constantly keeping the communications circuits powered up may drain the battery quickly. The high power drain caused by keeping the communications circuits operational may be one obstacle to wide deployment of such networks.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a network, according to an embodiment of the invention.

FIGS. 2A, 2B, and 2C show a method and timing diagram of a communications sequence involving coordinated low power modes in multiple network nodes, according to an embodiment of the invention.

FIG. 3 shows a block diagram of a wireless device that may operate as a network node, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions contained on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include, but is not limited to, read only memory (ROM), random access memory (RAM), magnetic disk storage media, optical storage media, flash memory devices, etc. A machine-readable medium may also include a tangible medium through which electrical, optical, acoustical or other form of propagated signals (e.g., carrier waves, infrared signals, digital signals, etc.) may pass, such as but not limited to the antennas and/or interfaces that transmit and/or receive those signals, fiber-optic cables, etc.

Some embodiments of the invention may use a coordinated network sleep/wake technique in a hierarchical network. During the network wake mode, the various nodes may communicate up (to a parent node) and down (to a child node) in a hierarchical network structure using a normal communications operation. In the network sleep mode, each node may be in a non-operational low power mode much of the time, but may periodically exit the low power mode for a brief communication with its parent node and/or child node(s) before going back into the low power mode. Although it may be possible to communicate data up or down the network structure while the network is in a sleep mode, the network bandwidth may be greatly reduced during the sleep mode since most of the nodes may be in a non-operational state much of the time. Within the context of this document, a low power mode may comprise a state in which the node's radio, the node's processor, or both are in an essentially non-operational low power state. The low power state may make use of any feasible low power techniques, such as but not limited to: 1) disconnecting the power source from all or part of the associated circuitry, 2) reducing a voltage to all or part of the associated circuitry, 3) stopping a clock to all or part of the associated circuitry, 4) reducing the frequency of a clock to all or part of the associated circuitry, 5) etc. Although the embodiments described herein may use the root node to initiate a sleep mode or a wake mode for the entire network, some embodiments may use a branch node to initiate a sleep mode or a wake mode only for the nodes beneath it in the hierarchy.

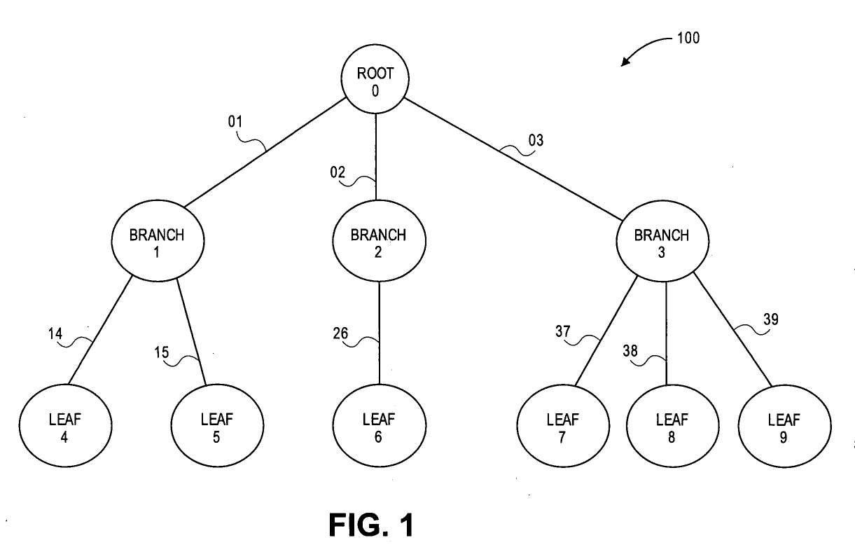

FIG. 1 shows a diagram of a network, according to an embodiment of the invention. In network 100, the network nodes 0-9 may communicate with each other through network links 01, 02, etc. The network nodes may be wireless devices that communicate through radio signals. Each network node may comprise one or more of each of the following: a processor, a memory, a radio, and an antenna. In some embodiments the processor(s) may be used, among other things, to determine what information to transmit, what to do with received information, to control internal processes, to enter low power modes, and to interact with other local devices. The memory may comprise any feasible type of memory, such as but not limited to dynamic random access memory (DRAM), static random access memory (SRAM), flash memory, or other types of memory. The radio(s) may be used to convert the digital signals used by the processor(s) into radio-frequency signals suitable for transmitting through the antenna(s), and to convert the radio-frequency signals received by the antenna(s) into digital signals suitable for use by the processor(s).

For convenience and clarity of explanation, the illustrated communication links of FIG. 1 are numbered in such a way as to indicate which two devices communicate over that link. For example, link 01 is the communications link between node 0 and node 1, link 37 is the communications link between node 3 and node 7, etc. In some embodiments the links are bi-directional, i.e., node 6 may receive signals from node 2 and node 2 may receive signals from node 6, over link 26. In some embodiments the term ‘link’ implies that the content of the messages (e.g., source and/or destination addresses) establish which devices are communicating with those particular messages, rather than implying that the devices on the link are the only ones that can perceive the existence of the message. For example, in some embodiments a message from node 0 to node 2 might be detected by many (or even all) the nodes in the network, but all nodes other than node 2 would ignore the message, because only node 2 would be addressed in the message. Although links based on source/destination addresses are described here, other embodiments might employ other methods of establishing a point-to-point link between two nodes.

Network 100 of FIG. 1 shows a hierarchical network configuration having an inverted tree structure for coordinated low power modes, although other embodiments may employ other network structures. In some embodiments the network hierarchy/configuration for coordinated low power modes as described herein may be different than the network hierarchy/configuration for other network operations. Node 0 is labeled the ‘root’ node, and has communications links with nodes 1, 2, and 3, which are labeled ‘branch’ nodes. Each branch node has communications with one or more of the ‘leaf’ nodes 4-9. In general, decision-making authority for power control may flow downward in such a network configuration, e.g., the root node may issue commands to its branch nodes, and each branch node may issue commands to each of its leaf nodes. Since the leaf nodes have no nodes below them in the illustrated network, in some embodiments they would not issue commands to any other nodes. Although three levels of nodes are shown, a network may have any feasible number of levels (e.g., it could have multiple levels of branch nodes), and not all parts of the network need to have the same number of levels. The terms ‘root’, ‘branch’, and ‘leaf’ are used here only for convenience. Other terms may be used without changing the scope of various embodiments of the invention.

In some embodiments, the network structure shown may be for certain types of operations, but a different network structure may be established by the same nodes for other types of operations. For example, the structure shown may be used to coordinate low power modes for the various network nodes, but an emergency communications protocol might allow any node to communicate with any other node for a different purpose, using link configurations other than those shown. In some embodiments the structure used for the same operations may be dynamically changed. For example, in the event that branch node 2 becomes inoperable, node 6 might establish a direct link to either node 0, node 1, or node 3.

In a network structure such as that shown in FIG. 1, it may be desirable to have each of the various nodes enter a low power mode in which the node does not communicate with other nodes. For example, if the node is battery-powered, spending a great deal of time in the low power mode may greatly extend battery life. Since communicating up and down the tree structure may only take place when the two nodes at either end of a link are both operational, coordinating the times during which those two nodes are awake or in a low power mode may facilitate overall network communications.

In general, the low power modes may be coordinated in the following manner: 1) The root node may send a sleep command to the branch nodes below it in the tree structure. 2) After receiving the sleep command, each of the branch nodes may send a sleep command to each of the nodes below it in the tree structure. This may continue for as many levels of nodes as there are in the structure, until every leaf node has received a sleep command. 3) Each leaf node may send an acknowledgement back up to the branch node that sent it the sleep command. The leaf node may ascertain the time period during which the leaf node will be in the low power mode, and then the leaf node may enter the low power mode for that time period. In some embodiments, every leaf node that reports to the same branch node will enter and/or exit the low power mode at approximately the same time. 4) Once the branch node has determined that every leaf node reporting to it has entered (or is about to enter) the low power mode, the branch node may send an acknowledgment to the root node, ascertain a time period during which the branch node will cease communications with the root node, and then cease communications with the root node during that time period. In some embodiments, every branch node that reports to the root node will enter and/or exit the period of non-communication at approximately the same time. 5) When the leaf nodes exit the low power mode at the end of the applicable time period, those leaf nodes may communicate with their branch node under whatever communications protocol is then in effect. The leaf nodes may then re-enter the low power mode using whatever protocol is in effect, including ascertaining what time to spend in the low power mode and then entering the low power mode for that period of time. 6) In a similar manner, once the branch nodes exit the period of non-communication, they may communicate with the root node using whatever protocol is in effect, and may then re-enter another period of non-communication using whatever protocol is in effect, including ascertaining what time to spend in the period of non-communication and then entering that period of non-communications.

In the sequence just described, the branch nodes were described as being in a period of non-communication rather than a low power mode. This is because, at least in some embodiments, the period of the leaf nodes' low power mode and the period of non-communication with the root node may only partially overlap. If the branch node is using the same antenna and/or radio and/or processor for communicating with both the root node and the leaf nodes, it may be feasible to place those elements into a non-operational low power mode only when the two time periods overlap. Also, even though only three levels of nodes are described, the same basic procedures may be applied to four or more levels, by applying the operations of the branch node (communicating with a node above it and also with nodes below it in the tree structure) to any feasible number of levels between the root node and the leaf nodes.

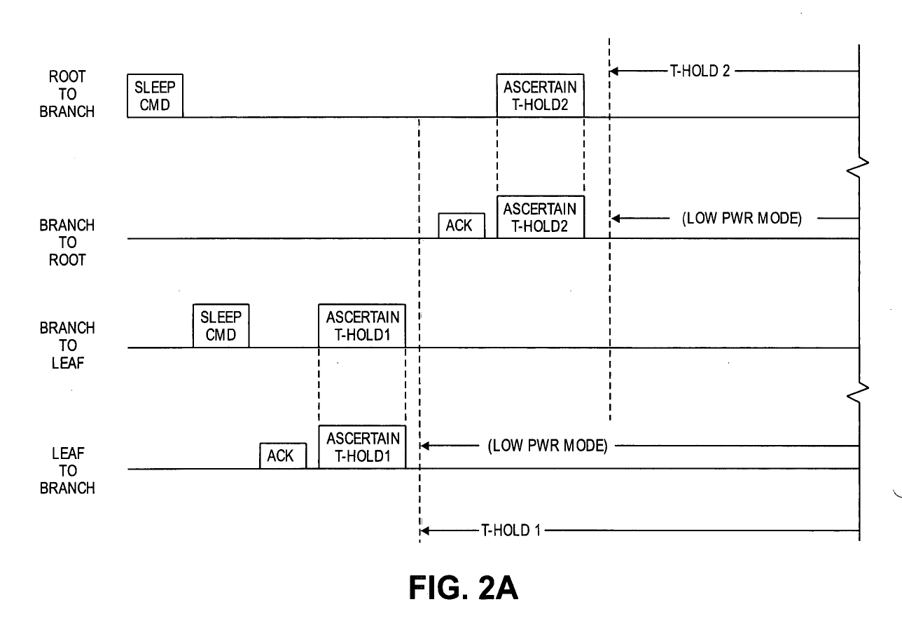

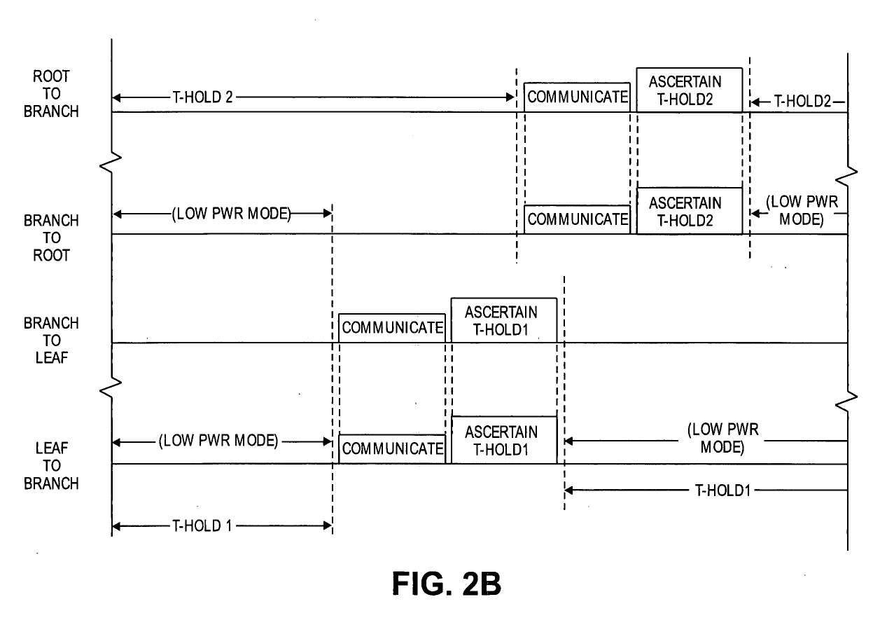

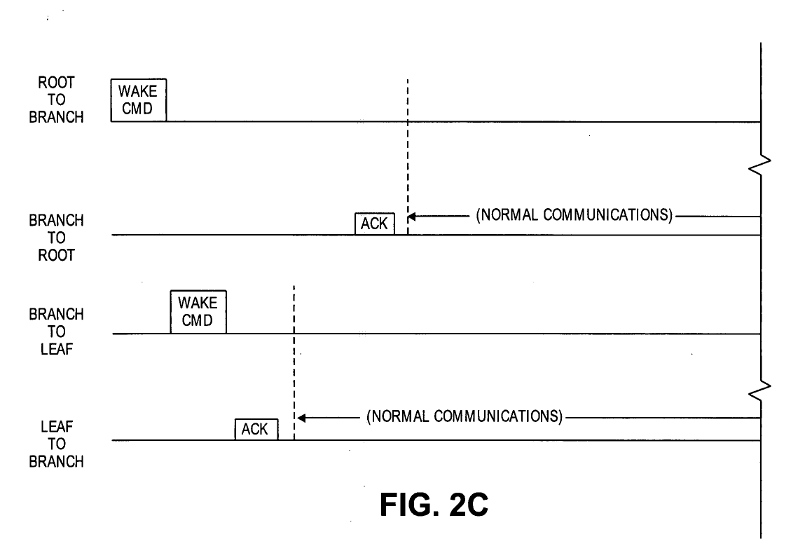

FIGS. 2A, 2B show a method and timing diagram of a communications sequence involving coordinated low power modes in multiple network nodes. The timing diagrams illustrate communications among three levels: a root node, a leaf node, and a branch node which communicates with both the root node and the leaf node. The first two lines of FIGS. 2A, 2B show communications between the root node and the branch node (e.g., over the link 01 between nodes 0 and 1), while the third and fourth lines of FIGS. 2A, 2B show communications between the branch node and the leaf node (e.g., over the link 14 between nodes 1 and 4). In some embodiments the same radio and antenna may be used by the branch node to communicate with both the root node and the leaf node, but other embodiments may use separate radios and/or antennas for each link.

In the illustrated sequence of FIG. 2A, a root node may send a sleep command to a branch node, directing the branch node to enter a low power mode. In some embodiments, a sleep command is not a command to enter a low power mode immediately, but rather a command to enter a low power mode after certain other events have taken place. Upon receipt by the branch node of the sleep command, the branch node may send a sleep command to a leaf node (or to the branch node below it in networks having multiple levels of branch nodes). This sleep command may have the same or a different form than the sleep command sent from the root node to the branch node. In some networks, a root node may send a sleep command to each of several different branch nodes, and each of the branch nodes may send a sleep command to each of several different leaf nodes (or to several different branch nodes if there are multiple levels of branch nodes). But for ease of understanding, most of the description herein follows the sequence through a single chain of nodes.

After receiving the sleep command, the leaf node may send an acknowledgement back to the branch node to indicate to the branch node that the leaf node has received the sleep command. In some embodiments, the leaf node and/or branch node may then ascertain more specific details of the period of time that the leaf node is to be in the low power mode. Such details may include one or more of, but are not limited to: 1) the start time of the low power mode, 2) the duration of the low power mode, 3) what type of low power mode, 4) etc. Each of the details may be ascertained in any of various ways, including but not limited to: 1) the branch node may dictate the details, 2) the details may be pre-determined, 3) the details may be negotiated between the branch node and the leaf node, 4) the leaf node may look up the details in a table, 5) etc. The period of time for the leaf node to be in the low power mode is indicated in FIG. 2A as T-hold1. Once the details of T-hold1 have been ascertained by both the leaf node and the branch node, and are therefore known to both the leaf node and the branch node, the leaf node may enter the low power mode for that time period, using a timer of some kind to determine when the time period expires. In some embodiments, all the leaf nodes reporting to a particular branch node may have their T-hold1 period determined such that they enter and/or exit a low power mode at approximately the same time. Other embodiments may use other techniques (e.g., the T-hold1 periods for the various leaf nodes may be staggered).

Once the branch node knows that the leaf node has entered the low power mode, or is to enter it at a known time, the branch node may use a timer of some type to measure the duration of the T-hold1 time period, so that the branch node will know when the leaf node is to exit the low power mode. The timers used by the various nodes may be of any feasible type, such as but not limited to: 1) a digital counter, 2) an analog timer, 3) etc., and the expiration of that time period may be indicated in any feasible manner, such as but not limited to: 1) an interrupt, 2) monitoring a counter, 3) a change of state of one or more bits in a register, 4) etc.

Once the branch node knows that every leaf node that reports to it has entered a low power mode, the branch node may send an acknowledgement to the root node. The branch node and the root node may then ascertain a time period during which the branch node and the root node will not communicate with each other. This time period is indicated in FIG. 2A as T-hold2. This time period may be ascertained in various ways, as previously described for the leaf nodes. From the point of view of the root node, this time period T-hold2 may be considered a time during which the branch node may be in a low power mode. However, since time period T-hold2 and time period T-Hold1 may not coincide exactly, the branch node may need to communicate with the leaf nodes during some portion of time period T-Hold2. In some embodiments the branch node may be in a low power mode only when time periods T-Hold1 and T-Hold 2 substantially overlap. This is illustrated on the second line of FIG. 2A and FIG. 2B. In other embodiments, the branch node may use separate processors and radios to communicate with the root node and the branch nodes, respectively, and may independently place each processor/radio into a low power mode during the applicable T-hold period.

Once the time period T-hold1 expires and the leaf node exits the low power mode, the branch node may communicate with that leaf node as indicated in FIG. 2B. After such communications, the branch node and leaf node may ascertain the details of another T-Hold1 period, and the leaf node may enter a low power mode again. The branch node may also communicate with other leaf nodes after they exit their own low power modes, and those leaf nodes may then re-enter their own low power modes in a similar manner. The communications between the branch node and its various leaf nodes may be staggered, may be concurrent, or may follow any other feasible timing relationship.

In a similar manner, once the time period T-hold2 expires, the root node and the branch node may communicate with each other, after which they may ascertain the details of another T-Hold2 period, and the branch node may then enter another period of non-communication with the root node. The root node may also communicate with other branch nodes after their periods of non-communication expire, after which they may also re-enter another period of non-communication in a manner similar to that just described. The communications between the root node and the various branch nodes may have any feasible timing relationships with respect to each other.

FIGS. 2A and 2B pertain to operations related to placing a network into a sleep mode and maintaining the network in that sleep mode. FIG. 2C pertains to taking the network out of the sleep mode. In the illustrated embodiment of FIG. 2C, the root node may transmit a wake command to each of its branch nodes. A wake command may indicate that the device receiving the wake command is to resume normal communications with the device transmitting the wake command (i.e., communications without the restrictions of a sleep mode). Each branch node may then transmit a wake command to each of its leaf nodes (or to each of other branch nodes in a network having multiple levels of branch nodes). The wake commands from the branch nodes may have the same or a different form as the wake commands from the root node. Once a leaf node receives the wake command, it may transmit an acknowledgment to the branch node from which it received the wake command. Normal communications (i.e., communications without the restrictions of the sleep mode) may subsequently resume between the leaf node and its branch node.

After the branch node receives an acknowledgment from each of its leaf nodes, it may send an acknowledgement to its root node (or to a higher-level branch node if there are multiple levels of branch nodes). Normal communications may subsequently resume between the branch node and the root node (or the higher-level branch node.

In the manner previously described, a network with a hierarchical link configuration (or a subset of that network) may be placed into a sleep mode, one level at a time. The network (or subset thereof) may subsequently be caused to exit the sleep mode, also one level at a time. While in the sleep mode, the nodes at each level may spend much of the time in a non-operational low power mode, while exiting the low power mode briefly to communicate one level up (or down) before re-entering the low power mode. In some embodiments the commands to enter or exit the sleep mode may propagate down through the network hierarchy, while the operations of entering or exiting the sleep mode may proceed up through the network hierarchy.

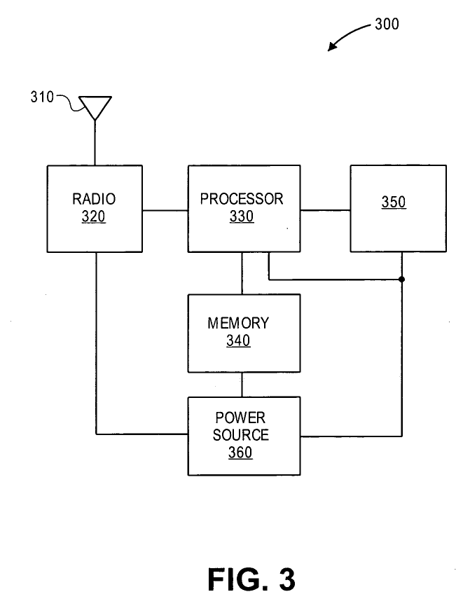

FIG. 3 shows a block diagram of a wireless device that may operate as a network node, according to an embodiment of the invention. In the illustrated embodiment, wireless device 300 may comprise an antenna 310, a radio 320 which may transmit and receive signals through the antenna 310, a processor 330 to perform the processing necessary to operate the wireless device 300 as a network node, a memory 340 to contain instructions and data, and other circuitry 350 as needed. In some embodiments circuitry 350 may comprise various elements, such as but not limited to a sensor, input-output device, timer, etc. Wireless device 300 may also comprise a power source 360 (such as, but not limited to, a battery) to provide operating power to other portions of the wireless device. Although FIG. 3 shows only one each of the antenna, processor, memory, power source, etc., some embodiments may contain more than one of any or all of these things.

The foregoing description is intended to be illustrative and not limiting. Variations will occur to those of skill in the art. Those variations are intended to be included in the variations embodiments of the invention, which are limited only by the spirit and scope of the appended claims.

What is claimed is:

1. An apparatus, comprising a wireless device to operate as a first network node in a network, the wireless device to:
receive a first command from a second network node to enter a first low power mode;
send a second command to a third network node to enter a second low power mode;
receive a first acknowledgement from the third network node responsive to the second command;
ascertain a first time period during which the third network node is to be in the second low power mode;
begin the first time period;
send a second acknowledgement to the second network node responsive to the first command; and
ascertain a second time period during which the first and second network nodes do not communicate with each other.

2. The apparatus of claim 1, further comprising entering the first low power mode for a time during which the first and second time periods overlap.

3. The apparatus of claim 2, wherein:
the wireless device comprises a radio, and
the first low power mode comprises a state in which the radio is in a low power state.

4. The apparatus of claim 1, wherein the network is configured such that the first, second, and third network nodes are in a hierarchical network structure.

5. The apparatus of claim 1, wherein the wireless device is further to:
send a third command to a fourth network node to enter a third low power mode;
receive a third acknowledgement from the fourth network node responsive to the third command;
begin a third time period during which the fourth network node is to be in the third low power mode; and
send the second acknowledgement to the second network node only after receiving the first and third acknowledgements.

6. The apparatus of claim 5, wherein the first and third time periods are to end at approximately a same time.

7. The apparatus of claim 1, wherein the wireless device comprises a dynamic random access memory.

8. The apparatus of claim 1, wherein the wireless device is further to:
communicate with the third network node subsequent to expiration of the first time period; and
ascertain a third time period during which the third network node is to be in another low power mode.

9. The apparatus of claim 1, wherein the wireless device is further to:
receive a third command from the second network node to resume normal communications between the first and second network nodes;
send a fourth command to the third network node to resume normal communications between the first and third network nodes;
receive a third acknowledgement from the third network node responsive to the fourth command;
resume normal communications between the first and third network nodes;
send a fourth acknowledgement to the second network node responsive to the third command; and
resume normal communications between the first and second network nodes.

10. A method, comprising
sending a first message to a first network node, the first message notifying the first network node of an intent for the first network node to enter a first low power mode;
receiving a first acknowledgement from the first network node responsive to the first message;
beginning to measure a first time period known to the first network node, the first time period indicating a time during which the first network node is to be in the first low power mode; and
not communicating with the first network node until after expiration of the first time period.

11. The method of claim 10, further comprising determining in communications with the first network node, prior to said beginning, the first time period.

12. The method of claim 10, further comprising:
receiving a second message from a second network node prior to said sending the first message;
sending, subsequent to said receiving the first acknowledgement, a second acknowledgement to the second network node responsive to the second message;
beginning to measure a second time period known to the second network node; and
not communicating with the second network node during the second time period.

13. The method of claim 12, further comprising:
sending a third message to the first network node, the third message notifying the first network node to not re-enter the first low power mode; and
receiving a third acknowledgement from the first network node responsive to the third message.

14. The method of claim 13, further comprising:
receiving a fourth message from the second network node prior to said sending the third message, the fourth message indicating to resume normal communications with the second network node;
sending a fourth acknowledgement to the second network node subsequent to said receiving the third acknowledgment; and
resuming said normal communications with the second network node.

15. The method of claim 10, further comprising entering a second low power mode during a period in which the first and second time periods overlap.

16. The method of claim 15, wherein the second low power mode comprises placing a radio in a low power state.

17. The method of claim 15, wherein the second low power mode comprises placing a processor in a low power state.

18. An article comprising
a machine-readable medium that provides instructions, which when executed by a computing platform, result in at least one machine performing operations comprising:
sending a first message to a first network node, the first message notifying the first network node of an intent for the first network node to enter a first low power mode;
receiving a first acknowledgement from the first network node responsive to the first message;
beginning to measure a first time period known to the first network node, the first time period indicating a time during which the first network node is to be in the first low power mode; and
not communicating with the first network node until after expiration of the first time period.

19. The article of claim 18, further comprising determining in communications with the first network node, prior to said beginning, the first time period.

20. The article of claim 18, further comprising:
receiving a second message from a second network node prior to said sending the first message;
sending, subsequent to said receiving the first acknowledgement, a second acknowledgement to the second network node responsive to the second message;
beginning to measure a second time period known to the second network node; and
not communicating with the second network node during the second time period.

21. The method of claim 20, further comprising:
sending a third message to the first network node, the third message notifying the first network node to not re-enter the first low power mode; and
receiving a third acknowledgement from the first network node responsive to the third message.

22. The method of claim 21, further comprising:
receiving a fourth message from the second network node prior to said sending the third message, the fourth message indicating to resume normal communications with the second network node;
sending a fourth acknowledgement to the second network node subsequent to said receiving the third acknowledgment; and
resuming said normal communications with the second network node.

23. The article of claim 18, further comprising entering a second low power mode during a period in which the first and second time periods overlap.

24. The article of claim 23, wherein the second low power mode comprises placing a radio in a low power state.

25. The method of claim 23, wherein the second low power mode comprises placing a processor in a low power state.
